(19) United States
(12) Patent Application Publication
(10) Pub. No.: US 2015/0210132 A1
(43) Pub. Date: Jul. 30, 2015

(54) RETROFITTABLE AND INTERCHANGEABLE, HITCH TIGHTENING RECIEVER ASSEMBLY

(71) Applicant: RICKEY JAY CHRISTENSEN, ROSAMOND, CA (US)

(72) Inventor: RICKEY JAY CHRISTENSEN, ROSAMOND, CA (US)

(21) Appl. No.: 14/164,237

(22) Filed: Jan. 26, 2014

(51) Int. Cl. B60D 1/24; B60D 1/52

(52) U.S. Cl. CPC B60D 1/241; B60D 1/52

(57) ABSTRACT

A hitch/receiver tightening assembly comprises a hitch pin device and an improved receiver to rigidly mount a common commercially available hitch. The improved receiver is like any of the common commercially available receivers except that one or more of the holes for the hitch pin is non-round. Equivalent strength, anti-rattle, anti-play, and component interchangeability with common commercially available systems is created. The improvement works with essentially all common commercially available hitches without change of same.

### BACKGROUND

1. Field

The improvement relates to receivers, hitches, and pins to attach same, and particularly to devices that reduce the relative movement between receivers and hitches.

2. Background Information

Receivers are attached to many vehicles. Receivers can be purchased after market or can be fitted to vehicles by custom fabricators. Many receivers are supplied as original vehicle equipment. Receivers come in many sizes. Receivers sometimes have different weight classifications within the same size. Receivers come in different geometries. Most receivers utilize square tube, some utilize round tube, others are rectangular, and a few are different shapes. Receivers are well known devices to many Americans.

Hitch devices that go inside receivers and are made secure, come in many forms. Trailer hitches are likely the most common device. Trailer hitches come with different size balls to mount trailers on. Trailer hitches can be load leveling or anti-sway devices. Trailer hitches come in different heights. Trailer hitches come with solid or hollow bodies. Trailer hitches can have many other variables to their design. Trailer hitches come for-different size receivers. Hitches are available for many functions. Hitches can also be bike racks, ski racks, winches, cargo carriers, steps, pintle hooks, advertisements, license plate holders, shower assemblies, clay pigeon throwers, etc. Adapters that change one receiver size to another are common.

There can be many hitches used in a single receiver.

To assemble a functional unit a hitch is inserted into a comparable receiver until the round holes in both items align. A pin is inserted. The pin is secured. To allow this assembly, there must be clearance between receiver and hitch as well as between the pin and holes. This allows detrimental movement of the hitch in relation to the receiver.

One detrimental effect is rattling. Rattling can cause unwanted wear and unwanted noise and other ill effects.

Another detrimental effect is increased play. Larger deflections, sometimes called play, can decrease towing quality. Play also decreases the effectiveness of anti-sway towing hitches, and can have bad effects on many of the different hitch devices. Play usually involves much larger forces than play.

To improve receiver hitch assemblies, rattling and play need to be minimized.

One receiver and one pin can attach many hitch devices. There are likely many more hitches than receivers or pins. Improvements that are accomplished in only the receivers and pins should require the least modifications, to the fewest parts, to provide the most benefits. To be optimum an improvement should change only the receivers and pins. An improvement also needs to accept essentially all currently used hitches of both solid and hollow construction.

Because many receiver sizes exist, an improvement needs to be scalable to different size receivers. Such an improvement would then be available to more users.

Anti-play is the elimination of excess deflection or play. Anti-play can be similar to the anti-rattle function, but must be able to deal with much larger forces. The anti-rattle function can work well with the smaller forces encountered in a bike rack hitch or ski rack hitch. Anti-play must be able to overcome the larger forces encountered in heavy towing. To not be limiting or unsafe, the anti-play improvement should be essentially as strong as the current standard hitch receiver systems in use. For a hitch to be pulled from the receiver the pin would have to shear at both sides of the receiver, called double shear. An improved hitch pin device needs to have at least the same nominal size as the standard pin. An improved hitch pin device that requires at least a double shear before failure is needed. This ensures that the improved hitch receiver assembly is equivalently as strong as the standard hitch receiver assembly.

This improvement could bring two types of receivers and two types of pins to frequent use. Optimally any combination of one receiver and one pin of the proper size should provide at least the common commercially available functionality if not the improved functionality. This will eliminate confusion between incompatible parts. Full compatibility between the improvement and the standard assembly is needed.

An improvement that can allow a standard receiver to be retrofitted to an improved receiver with only a small modification, will yield improved utility. An improved receiver that can be originally manufactured is needed concurrently. This would allow the largest number of receiver hitch assemblies to be improved. Many common commercially available receiver hitch assemblies are in public used.

The assembly sequence of a common commercially available is;

first, slide in hitch and align holes,

second, insert pin,

third, secure pin.

A large number of people follow this sequence by habit. Any assembly requiring a different assembly sequence could bring about disastrous results when someone somewhere will invariably follow their habit. For example, U.S. Pat. No. 8,079,612 B1 provides anti-rattle with a different assembly sequence. First a hitch device (not shown) is inserted into the receiver tube 22. Then by tightening fastener 52 the anti-rattle function will be activated. The next operation could be inserting the pin (not shown) into hole 38 and securing the pin. However, once the fastener 52 is tightened, the tightened condition of the hitch could give the false impression that the hitch is secure. The vehicle could drive off with an apparently but not actually secured hitch. The varying towing forces and the vibration that will ensue could cause the hitch to work out of the receiver tube 22 with possibly sad results. Staying as close as possible to the assembly sequence of the common commercially available assembly is best.

An assembly sequence similar to the common commercially available assembly sequence is needed.

In conclusion the improvement needs to be;

1, anti-rattle.

2, anti-play.

3 constrained to receiver changes and pin changes only; leaving hitches unchanged.

4, functional with common commercially available hitches of either solid or hollow construction.

5, scalable to work with all hitch sizes.

6, essentially as strong as the common commercially available assemblies.

7, compatible with combinations of improved assembly components and common commercially available assembly components.

8, able to be originally manufactured, or be made from small modifications to a common commercially available assembly.

9, of an equivalent assembly sequence to the common commercially available assembly sequence.

There exist several anti-rattle devices that work to varying degrees and have varying short comings. U.S. Pat. No. 8,079,613 B2 is prior art for anti-rattling but is not functional with common commercially available hitches of either solid or hollow construction. Also it seems not to be essentially as strong as the common commercially available assemblies, being in only single shear. In addition it is not compatible between combinations of improved assembly components and common commercially available assembly components. U.S. Pat. No. 8,079,612 B1 is also anti-rattle prior art but is not of an equivalent assembly sequence to the common commercially available assembly's sequence.

### BRIEF DESCRIPTION OF DRAWINGS

The retrofittable and interchangeable, tightening hitch and receiver assembly can be better understood in light of the following description of the figures and reference numerals.

List of figures, in which:

FIG. 1 is an exploded assembly perspective view of an improvement

FIG. 2 is an exploded assembly perspective view of a common commercially available assembly that is not claimed, but is shown for elucidation and comparison purposes

FIG. 3A is a side view that shows embodiment of square non-round thru holes in the receiver

FIG. 3B is a side view that shows embodiment of rectangular non-round thru holes in the receiver

FIG. 3C is a side view that shows embodiment of slotted non-round thru holes in the receiver

FIG. 4 is an exploded assembly view of the hitch pin device assembly

FIG. 5 is a cross section thru the hitch pin device showing the improvement utilizing a hollow section hitch

FIG. 6 is a cross section thru the hitch pin device showing the improvement utilizing a common commercially available hitch pin

FIG. 7 is a cross section thru the hitch pin device showing the improvement utilizing a solid section hitch

FIG. 8A is a side view of the common commercially available receiver with cross hatched areas around the hitch pin hole that, when removed, will yield an improved receiver

FIG. 8B is a side view of the common commercially available receiver with cross hatched areas around the hitch pin hole that, when removed, will yield an improved receiver

FIG. 8C is a side view of the common commercially available receiver with cross hatched areas around the hitch pin hole that, when removed, will yield an improved receiver

FIG. 8D is a side view of the common commercially available receiver with cross hatched areas around the hitch pin hole that, when removed, will yield an improved receiver

FIG. 8E is a side view of the common commercially available receiver with cross hatched areas around the hitch pin hole that, when removed, will yield an improved receiver

FIG. 8F is a side view of the common commercially available receiver with cross hatched areas around the hitch pin hole that, when removed, will yield an improved receiver

List of reference numerals, in which:

1 is a receiver

2 is a hitch (not claimed)

3 is a hitch pin device

3A is a hitch pin device handle

3B is a hitch pin device hilt

3C is a hitch pin device threaded shaft

4 is a hitch pin retainer (not claimed)

5 is a common commercially available hitch pin (not claimed)

6 is a common commercially available receiver (not claimed)

7 is a common commercially available nut (not claimed)

8 is a non-round hole in receiver 1

9A is the material to remove to modify 6 into 1 with a square non-round hole

9B is the material to remove to modify 6 into 1 with a rectangular non-round hole

9C is the material to remove to modify 6 into 1 with a slotted non-round hole

9D is the material to remove to modify 6 into 1 with a triangular non-round hole

9E is the material to remove to modify 6 into 1 with a keyhole non-round hole

9F is the material to remove to modify 6 into 1 with an offset slot non-round hole

### DESCRIPTION

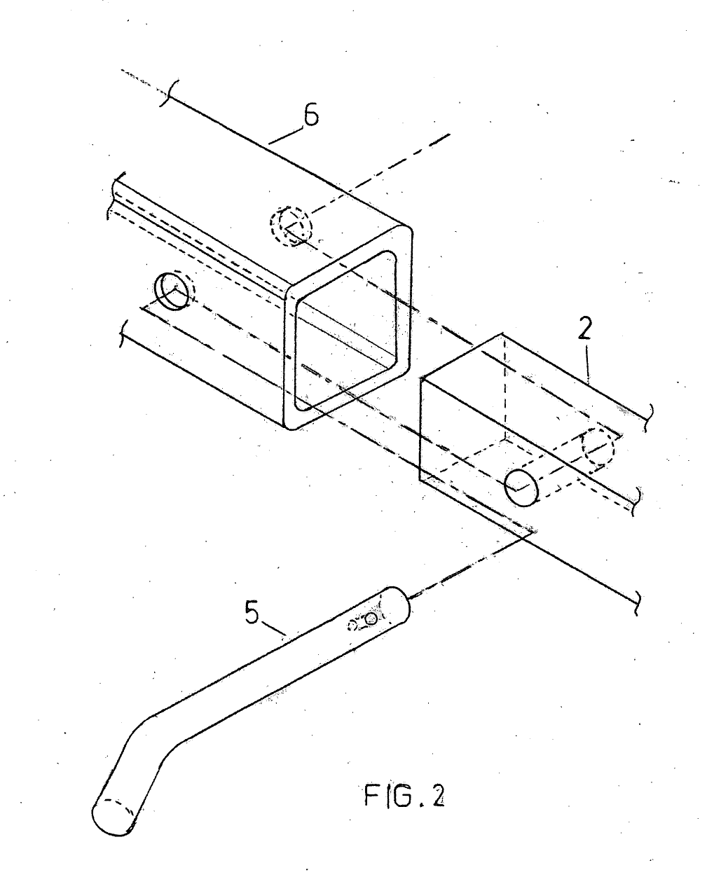

Referring to FIG. 2 the assembly sequence for a common commercially available receiver hitch assembly has three steps:
A, insert a hitch 2 into a common commercially available receiver 6 until their holes align,
B, insert a common commercially available hitch pin 5,
C, secure the pin with a hitch pin retainer 4.

This secures the hitch.

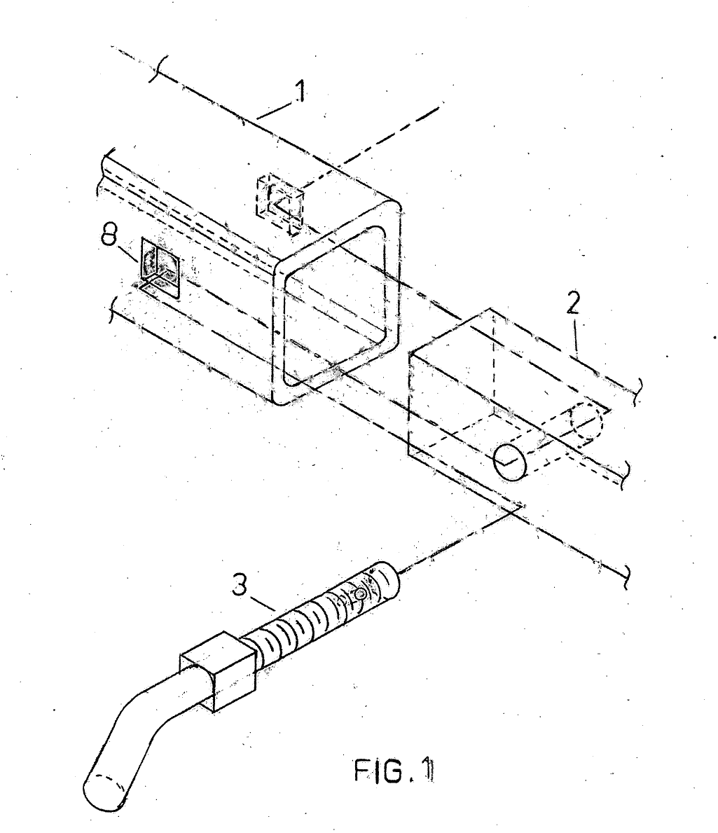

Referring to FIG. 1 the assembly sequence of the improvement has three steps:
A, insert hitch 2 into receiver 1 until their holes align,
B, insert hitch pin device 3
C, secure the pin with nut 7.

This secures the hitch with anti-play and anti-rattle properties.

The assembly sequence of the receiver hitch assembly and the improvement are essentially the same.

The difference between the receiver 1 and the common commercially available receiver 6 is that the hole in receiver 1 is a non-round hole 8. The non-round hole 8 has a predetermined acceptable geometry. To be of acceptable geometry, the non-round hole must satisfy three conditions:

First, the hole geometry must not allow more fore and aft movement of the hitch 2 than the common commercially available receiver 6 and the common commercially available hitch pin 5 utilizing round holes thus assuring a double shear condition

Second, the hole geometry must not allow the hilt of hitch pin device 3 to rotate in the receiver 1 when the nut 7 is tightened

Third, the non-round hole geometry must have more cross sectional area than the round hole, to allow a hitch pin device 3 to bear against the hitch 2.

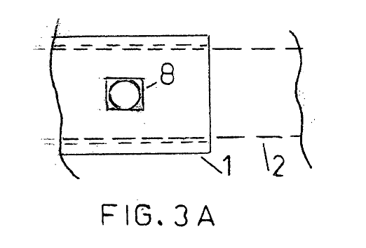

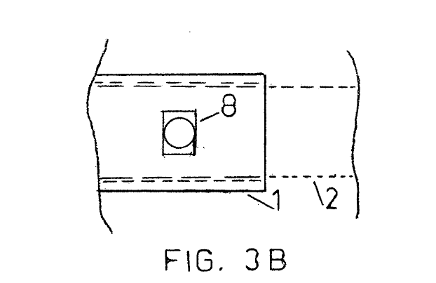

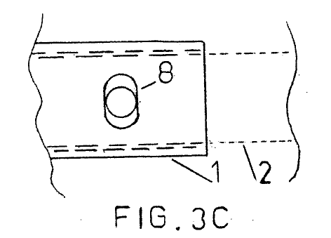

FIG. 1 shows the square hole geometry embodiment that is revealed in FIG. 3A.

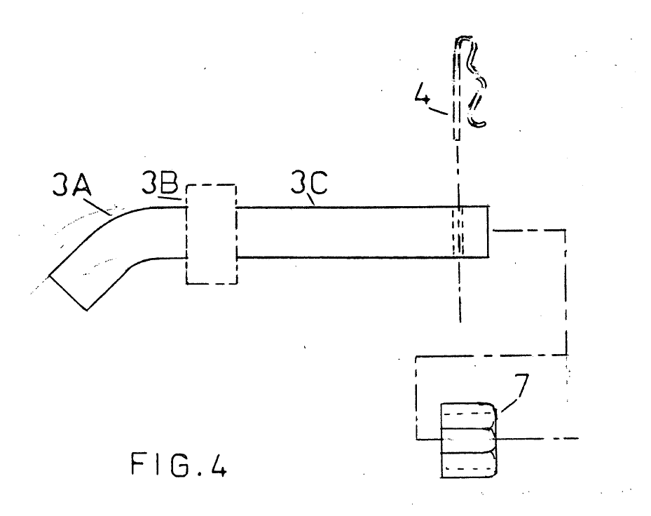

The hitch pin device is depicted in FIG. 4. The handle is reference numeral 3A. The hilt area of the hitch pin device is 3B. The cross section of the hilt perpendicular to the major axis of the hitch pin device is to be compatible with the non-round predetermined hole 8 geometry in the receiver 1. The hilt cross section is compatible with the non-round hole geometry of hitch 1 when it satisfies the three previously stated conditions. For example, a properly sized square cross section hilt would be compatible with the square hole geometry of FIG. 3A and the rectangular hole geometry of FIG. 3B as well as the slotted geometry of FIG. 3C. A properly sized rectangular cross section hilt such as FIG. 3B would be compatible with FIG. 3B and FIG. 3C but not the square geometry of FIG. 3A. If the hilt cross section matched the slot hole geometry of FIG. 3C then it would be compatible with only FIG. 3C and not FIG. 3B and not with FIG. 3A. The threaded shaft 3C of FIG. 4 is of the same nominal size as the common commercially available hitch pin 5. When the threaded shaft 3C is tightened with nut 7, the hitch 2 is pulled against the receiver 1.

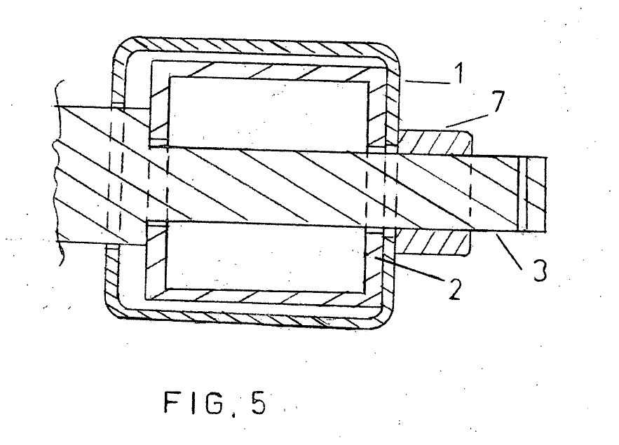

In FIG. 5 it is shown how the improvement also works equally well with hollow construction hitches 2. The improvement works with essentially all styles and types of common commercially available hitches.

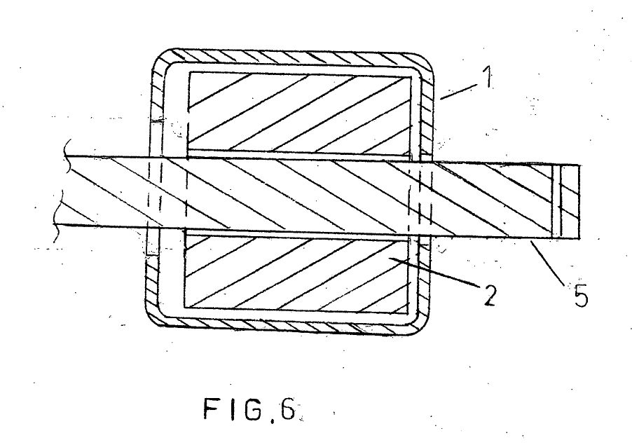

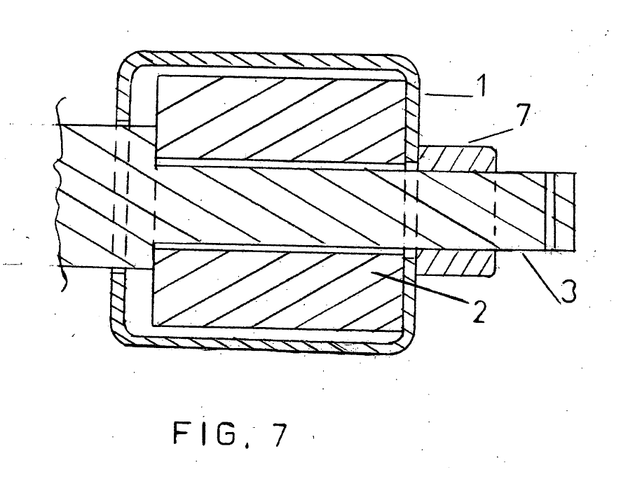

This improvement is fully compatible and interchangeable with common commercially available systems. FIG. 7 illustrates the improvement with the embodiment of non-round hole of FIG. 3B. FIG. 6 depicts the use of a common commercially available hitch pin with receiver 1. The system is secure but functions as the common commercially available system. If the hitch pin device is used on a common commercially available system, the results are the same: the system is secure but functions as the common commercially available system.

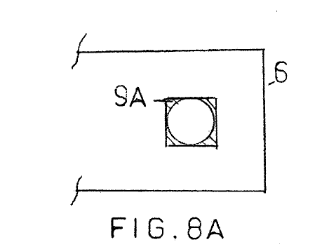

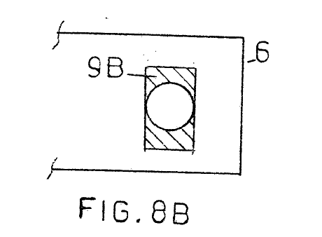

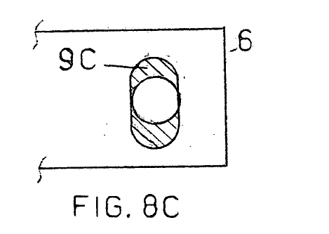

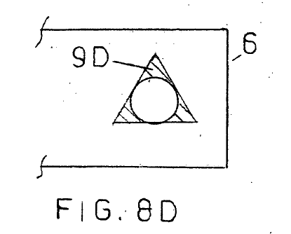

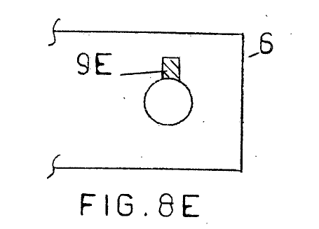

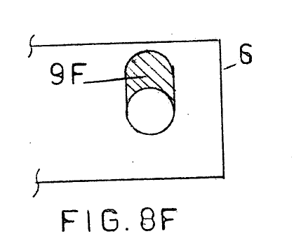

A common commercially available receiver 6 can be modified to a receiver 1. FIGS. 8A thru 8F are a few examples for different hole geometries. Simply removing the material shown in the cross hatched areas will yield an improved receiver 1. A new receiver 1 can also be originally manufactured by using a non-round predetermined hole geometry that meets the three requirements listed previously.

### OTHER EMBODIMENTS

There are many embodiments of the non-round hole 8. Three geometries are shown in FIG. 3A, FIG. 3B, and FIG. 3C as well as three additional geometries are shown in FIG. 8D, FIG. 8E, and FIG. 8F. By no means are the non-round holes 8 limited to these six geometries. Any non-round hole geometry meeting the three requirements stated previously in this description will provide the full function of this improvement. Even some company logos shapes meet the three requirements for non-round holes and might be employed. Those skilled in the art could specify an almost limitless number of non-round hole 8 geometries. Essentially all non-round hole 8 geometries that meet the three requirements stated previously could function equally well and meet the intent of this improvement. Multiple geometries and orientations of non-round holes 8 could be employed on the same receiver 1.

The handle 3A as well as the hitch pin retainer 4 shown, is similar to some common commercially available hitch pins 5. Using a different handle 3A, or no handle, or a different hitch pin retainer 4, or no hitch pin retainer, does not notably change the hitch pin device. The function, intent, scope, and use remain the same.

1. An article of manufacture titled retrofittable and interchangeable, hitch tightening receiver assembly for attaching multiple hitches to a tow vehicle comprising:
a hitch receiver adapted to be mounted to a tow vehicle, terminating in a rectangular tube, with two holes located at mid-dimension of the tube walls and configured as one round hole and one non-round hole of a predetermined acceptable geometry, allowing hitch(es) with rectangular outside dimensions nominally equal to the hitch receiver, to be inserted until the holes in the hitch receiver align with the horizontal thru hole of the hitch(es),
a hitch pin device with a hilt of predetermined acceptable geometry compatible with the predetermined acceptable hole pattern of the hitch receiver and a threaded shaft nominally the same size as the hole thru the hitch(es) of sufficient length to pass thru the receiver and accommodate a hitch pin nut and pin or locking device
whereby, hitch receiver and hitch pin device can provide anti-rattle and anti-play functions to virtually all commercially available hitches regardless of if hitch is of solid or hollow construction,
whereby also, receiver and hitch pin device concurrently provide the full equivalent strength of the load rated assemblies which utilize common commercially available receivers, hitch pins, and hitches,
whereby furthermore, the assembly sequence of hitch into receiver is essentially the same as common practice except for the additional step of tightening the hitch pin nut,
whereby finally, the invention of claim 1 and the invention of claim 2 may be utilized to fasten any accessory that utilizes the same interface as a hitch.

2. The invention of claim 1, wherein both holes in the hitch receiver tube walls are non-round holes of a predetermined acceptable geometry.

3. A method of constructing the invention of claim 1 by utilizing virtually any of a plethora of typical existing manufactured receivers which have opposing round hitch pin holes and modifying these receivers by modifying one round hitch pin hole to a non-round hole of a predetermined acceptable geometry by removing material and utilizing a hitch pin device of claim 1.

4. A method of constructing the invention of claim 2 by utilizing virtually any of a plethora of typical existing manufactured receivers which have opposing round hitch pin holes and modifying these receivers by modifying both round hitch pin holes to a non-round hole of a predetermined acceptable geometry by removing material and utilizing a hitch pin device of claim 1.
